(19) United States
(12) Patent Application Publication
(10) Pub. No.: US 2012/0215819 A1
(43) Pub. Date: Aug. 23, 2012

(54) TOOL FOR REMOVING INACTIVE OBJECTS

(75) Inventor: Vijay M. Gowdra, Karnataka (IN)

(73) Assignee: INTERNATIONAL BUSINESS MACHINES CORPORATION, Armonk, NY (US)

(21) Appl. No.: 13/033,340

(22) Filed: Feb. 23, 2011

(51) Int. Cl. G06F 17/30

(52) U.S. Cl. 707/822; 707/E17.01

(57) ABSTRACT

A method, system and computer program product for removing inactive objects from a file to produce a thinner file. In one embodiment, the method comprises identifying inactive objects in a specified object file, listing the identified inactive objects in an input file, and executing a tool to remove from the specified object file all of the objects listed in the input file. In one embodiment, the tool is used to generate a log file identifying defined information about the objects removed from the object file. In an embodiment, the tool removes all of the objects from the specified object file and checks to determine if each of the removed objects is listed in said input file. The tool deletes all of the objects listed in said input file and returns to the object file all of the objects not listed in said input file.

### BACKGROUND OF THE INVENTION

This invention generally relates to data processing, and more specifically, to removing inactive objects from files.

In many data processing projects, data objects become inactive. They may become inactive because they are no longer needed, or because they are replaced by more current objects or by objects that, for one reason or another, are better for an application.

These inactive objects may adversely affect or interfere with the operation of a computer or data processing system. For example, inactive objects may prevent optimal use of a memory, and may affect maintenance of the computer or data processing system.

As one specific example, Siebel Systems provides customer relationship management (CRM) software applications that include information files, or SIFs (Siebel Information Files). In long running applications, these files may accumulate large numbers of custom, inactive objects. These objects increase the sizes of the files, which is referred to as making the files fat. The inactive objects also may affect maintenance and may prevent memory optimization.

At the present, in order to remove custom inactive objects, each object needs to be checked manually and needs manual deletion. Manual deletion, however, has a number of important disadvantages. It is time consuming, error prone due to the work being monotonous, and does not provide any logs for future reference.

### BRIEF SUMMARY

Embodiments of the invention provide a method, system and computer program product for removing inactive objects from a file to produce a thinner file. In one embodiment, the method comprises identifying inactive objects of interest in a specified repository file, listing the identified inactive objects of interest in an input file, and executing a tool to read the input file and to remove from the specified repository file all of the inactive objects listed in the input file. In one embodiment, the tool is used to generate a log file identifying defined information about the inactive objects removed from the repository file. In an embodiment, the log file includes statistics on actions taken by the tool. In one embodiment, the tool also re-generates object files (SIFs) with only active objects. In one embodiment, a single configuration file is used to configure and run the tool.

In an embodiment, the tool removes all of the custom inactive objects from the specified object file and checks to determine if each of the removed objects is custom and inactive. The tool deletes all of the custom inactive objects (which can be referred to as attributes) from the object file and re-generates a new object file with only custom active objects.

In one embodiment, a backup is generated or created for the original object file.

In an embodiment, the tool removes from the object file all of the custom inactive objects (which can be referred to as attributes) in the object file that have a defined relationship. In one embodiment, the object file includes Object Hierarchy objects and Sub-Object Hierarchy objects (attributes), and both Object Hierarchy and Sub-Object Hierarchy objects are removed from the object file (if they are custom and inactive).

In one embodiment, the object file includes Object Hierarchy objects and Sub-Object Hierarchy objects, and each of the Sub-Object Hierarchy objects is a sub-object of one of the Object Hierarchy objects. When one of the Object Hierarchy objects is custom and inactive, that Object Hierarchy object and all of its Sub-Object Hierarchy objects are removed from the object file.

In an embodiment, the tool is used to configure custom strings based on which inactive objects are removed from the object file. The master configuration file has a place holder that takes the name of the custom string. This string, in turn, is used by the algorithm of the tool during processing to make decisions whether to delete or retain an inactive object.

The tool of embodiments of the present invention provides an automated way to report and delete the custom inactive objects. The tool also allows configuration of custom strings based on which inactive objects can be deleted.

The tool, in embodiments of the invention, has a number of significant advantages. For instance, the tool can accept Object Hierarchy object names to work on. Also, the tool can generate before and after SIFs—the “before” SIFs being original SIFs, and the “after” SIFs being the thin downed versions of the SIFs after deleting inactive Sub-Object Hierarchy objects.

The tool, in embodiments of the invention, can be used to generate log files (CSV (Comma Separated Values)) with decisions taken. Further, the tool is easy to use, is quick, is a time saving process, and is reliable. In embodiments of the invention, a master configuration file may be used that will make it easy to configure the tool (a one-time activity).

### BRIEF DESCRIPTION OF THE SEVERAL VIEWS OF THE DRAWINGS

FIG. 1 is a high level view of a thin SIF creator in accordance with an embodiment of the invention.

FIG. 2 illustrates the operation of the thin SIF creator in an embodiment of the invention.

FIG. 3 illustrates an example of an embodiment of the invention.

FIG. 4 gives pseudo code for an implementation of an embodiment of the invention.

FIG. 5 shows a computing environment that may be used to implement this invention.

### DETAILED DESCRIPTION

As will be appreciated by one skilled in the art, embodiments of the present invention may be embodied as a system, method or computer program product. Accordingly, embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium, upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Embodiments of the invention provide a method, system and computer program product for removing inactive objects from a file to produce a thinner file. Accordingly, embodiments of the invention are referred to as thin file creators. In one embodiment, the method comprises identifying inactive objects of interest in a specified repository file, listing the identified inactive objects of interest in an input file, and executing a tool to read the input file and to remove from the specified repository file all of the inactive objects listed in the input file.

The tool of embodiments of the present invention provides an automated way to report and delete the inactive objects. The tool also allows configuration of custom strings based on which inactive objects can be deleted. The master configuration file has a place holder that takes the name of the custom string. This string, in turn, is used by the algorithm of the tool during processing to make decisions whether to delete or retain an inactive object.

The present invention can be used in many specific environments and with many specific applications and projects. As one example, the invention has been used with a group of customer relationship management (CRM) software applications from Siebel Systems (currently owned by Oracle). These applications include information files, referred to as SIFs; and in long running projects, these files may accumulate large numbers of custom, inactive objects. These objects increase the sizes of the files, and also may affect maintenance and may prevent memory optimization.

In an embodiment of the invention, once the objects of interest are identified, the next step is to list these objects of interest in the input file. The contents of the input file are the names of the objects on which the tool will operate. The tool automatically picks these objects from the repository and then acts on them. In this way, the input file tells the tool on which objects it has to operate on.

In an embodiment of the invention, the tool is used to remove custom inactive objects from a repository. Custom objects are created newly by developers (or anyone who is involved in customization) and are not present in the factory shipped product. Custom objects can be identified using a number of methods. Usually, the best practices recommend that any new custom object must start with a custom identifier, such as ABCxxx, that is used across an application. Also, the date of creation of an object can be used to determine whether an object is custom or not custom.

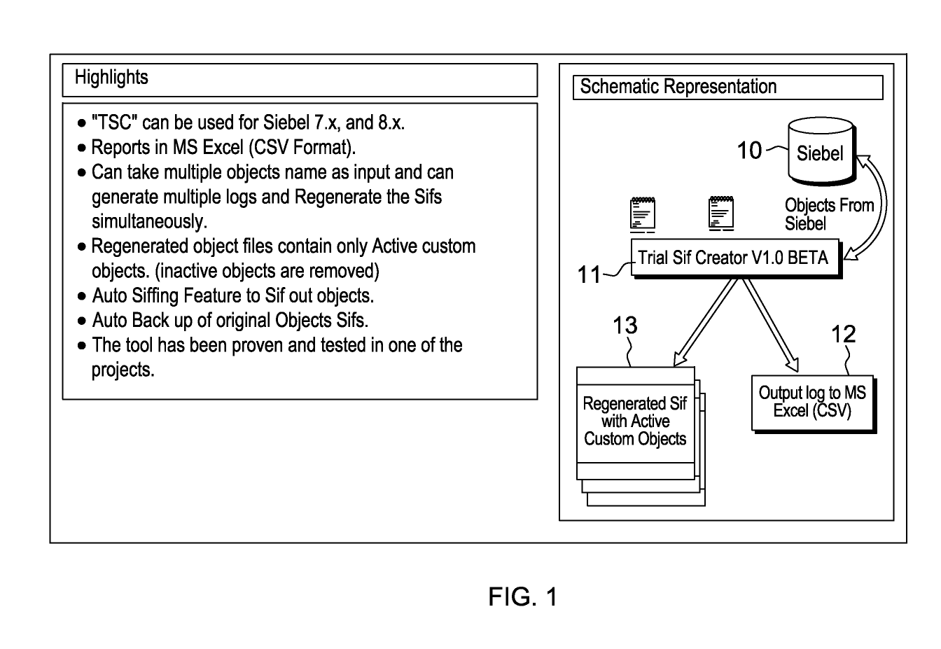

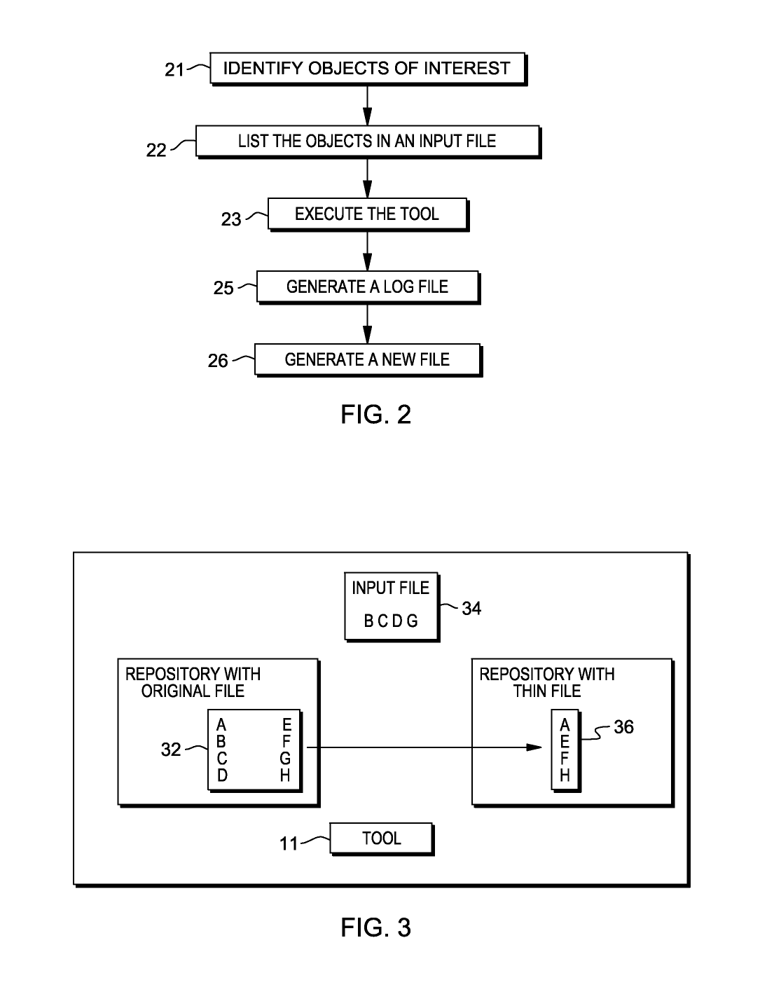

FIG. 1 is a high level view of a thin file creator in accordance with an embodiment of the invention, and FIG. 2 illustrates the operation of the thin file creator in an embodiment of the invention. The process and tool, in an embodiment of the invention, are described below with reference to FIGS. 1 and 2.

In FIG. 1, a repository of object files is represented at 10, and the tool for creating the thinner files is represented at 11. The logs created by the tool are represented at 12, and regenerated, thinner files are represented at 13.

With reference to FIGS. 1 and 2, in the implementation of tool 11, at step 21, objects of interest are identified by the user. The user can be anyone who can decide the list of objects on which the tool can be executed. Once the objects of interest are identified, then the next step 22 is to put a list of these objects into an input file. If there is more than one object, the object names can be separated by a comma.

Once the objects are listed in this input file, then the next step 23 is to execute the tool by, for example, running a simple command. When the tool is executed, at step 25, the tool generates a Siebel log file internally that shows details of the objects that were taken from the Repository 10, which is where all the objects are maintained.

Once the objects' information files (SIFs) are taken from the Siebel Repository, then, at step 26, the tool automatically starts the execution on the objects individually. The tool also starts to generate log files for each object executed, along with the new SIF. The new SIF can be imported back to the Repository 10, which then has only active custom objects.

The logs provide the statistics on the actions taken by the tool 11. The single configuration file of the tool makes it easy to configure and run the tool.

In an embodiment, the objects of interest are custom inactive objects in a specified file in repository 10, and these objects may be identified in any suitable way. For instance, these objects may be identified by a manual identification process or by using a tool which gives the ratio of active and inactive objects in the repository for every object. The identified objects may be listed in the input file in any suitable way. For example, the identified objects may be listed in the input file by a manual entry by an architect or by an application area owner.

Tool 11 may use any suitable procedure to read the input file. The algorithm implemented by the tool has the logic needed to read the input file. The tool gets the path of the input file from the master configuration file. In an embodiment, once the objects of interest are identified and listed in the input file, the tool scans through the specified repository file and identifies the objects with the inactive flag set to “Y.” These inactive objects are removed from the specified file.

In an embodiment, objects are removed from a particular file by generating, or re-generating, a new file without those inactive objects. In operation, the tool scans through the objects in that particular file; and for each object, makes a decision about whether to remove or retain the object. Each object that is to be retained is written into a new file; and each object that is to be removed, is not written into that new file. When the tool is completed scanning through the initial file—and all the custom active objects have been written into the new file—the new file is substituted for the initial file.

The tool, in embodiments of the invention, has a number of significant advantages. For instance, the tool can accept Object Hierarchy object names to work on. Also, the tool can generate before and after SIFs—the “before” SIFs being original SIFs, and the “after” SIFs being the thin downed versions of the SIFs after deleting inactive Sub-Object Hierarchy objects.

The tool, in embodiments of the invention, can be used to generate log files (CSV (Comma Separated Values)) with decisions taken. Further, the tool is easy to use, is quick, is a time saving process, and is reliable. In embodiments of the invention, a master configuration file may be used that will make it easy to configure the tool (a one-time activity).

In embodiments of the invention, the tool can be used across various Siebel implementations in an organization. This provides significant value to many clients. Also, not much time is needed to configure and run the tool.

The present invention, in embodiments, can be implemented as one of the best practices to perform clean-up activities in projects, either, for example, in Application Development Lifecycle or in Application Maintenance Phase.

The methodology of the present invention may be very helpful in organizations that are running multiple projects. Many projects have tight timelines; and the tool of the present invention will help teams do clean-up activities, and can perform these activities at a high level of quality in relatively small amount of time.

In some embodiments, the tool can be bundled up with other existing tools and sold as an added value to the clients.

FIG. 3 illustrates an example of an embodiment of the invention. In this example, an original file 32 in the repository includes, for example, eight objects, A-H. Objects B, C, D and G are inactive. A list of these inactive objects is entered in the input file 34. Tool 11 is used to read that list, and to remove objects B, C, D and G from file 32. In an embodiment, this is done by creating a new, thin file 36 in the repository with only the active objects A, E, F and H.

As one example, the tool of this invention was used in a project having many objects and a significant number of inactive Sub-Object Hierarchy objects. These objects were identified and processed automatically using the tool of the present invention. The Table below gives statistics for these objects before and after the objects were processed.

| OBJECT NAME | BEFORE SIF SIZE | AFTER SIF SIZE |
|---|---|---|
| POC Account.sif | 710 KB | 640 KB |
| POC Publish Account.sif | 740 KB | 670 KB |
| POC Action Asynchronous.sif | 330 KB | 220 KB |

Before SIF size means the file size before the tool's execution.
After SIF size means the file size after the tool's execution.

The above-table gives the difference, in bytes, between the object file size before and after the tool is executed (the representation is in XML format). As the table shows, there is a significant reduction in the file size since there are hundreds of objects where optimization can be performed. This, in turn, reduces the total size of the Siebel Repository and leads to efficient processing.

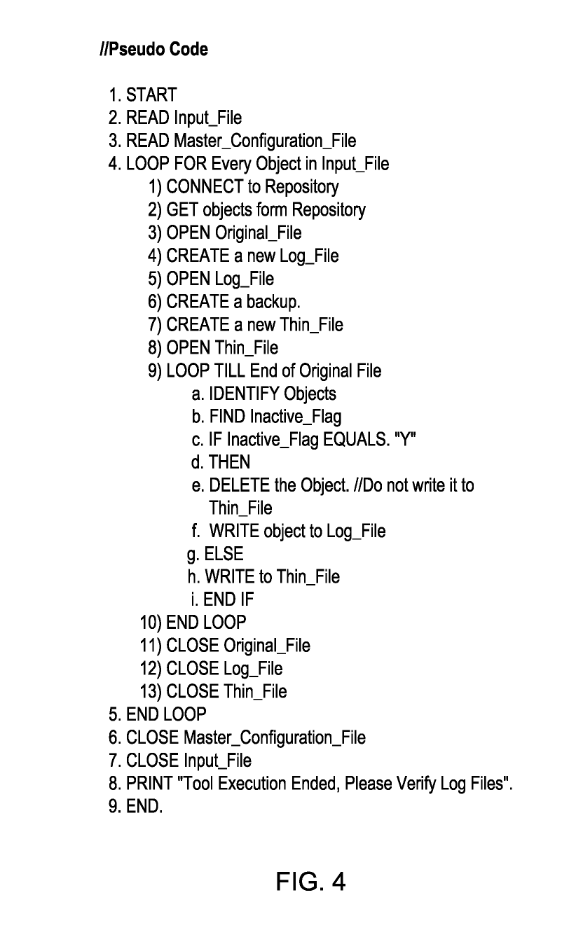

FIG. 4 shows pseudo code for an embodiment of the invention. With this embodiment, the input and master configuration files are read (lines 2 and 3). For each object in the input file, the algorithm proceeds through a loop (lines 3-9) to determine whether to retain or remove the object. The tool connects to the repository, gets the object from the repository, and opens the original file. The tool creates and opens a new log file, creates a backup file, and creates and opens a new, thin file. Then lines (4)(9)(a) through (4)(9)(i) are used to determine whether to retain the object—that is, write the object into the new thin file—or to remove the object—that is, not write the object to the new, thin file.

In particular, the object is identified, and the object's inactive flag is found. If the inactive flag is “Y,” the object is deleted—that is, not written into the new, thin file—and an entry is made in the log file. If the inactive flag is not “Y,” the object is retained, that is, written into the new, thin file. The original file, the log file and the thin file are closed (lines (4)(11)-(4)(13), and the master configuration file and the input file are also closed (lines 6 and 7).

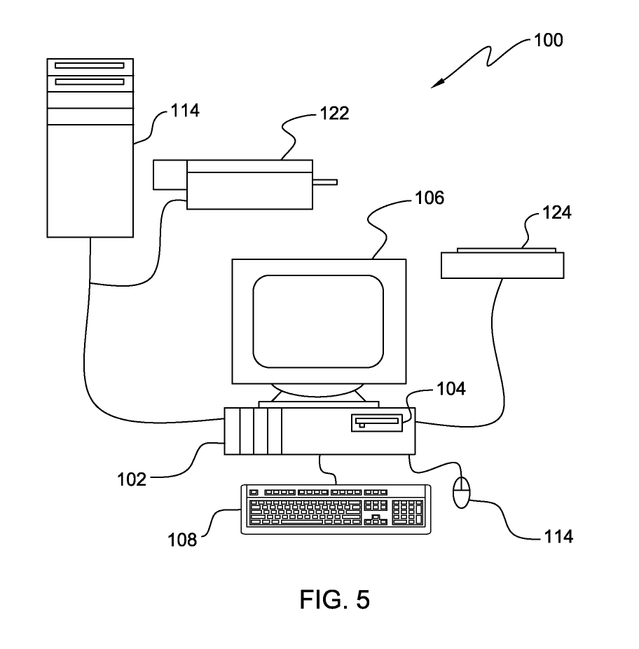

A computer-based system 100 in which a method embodiment of the invention may be carried out is depicted in FIG. 5. The computer-based system 100 includes a processing unit 102, which houses a processor, memory and other systems components (not shown expressly in the drawing) that implement a general purpose processing system, or computer that may execute a computer program product. The computer program product may comprise media, for example a compact storage medium such as a compact disc, which may be read by the processing unit 102 through a disc drive 104, or by any means known to the skilled artisan for providing the computer program product to the general purpose processing system for execution thereby.

The computer program product may comprise all the respective features enabling the implementation of the inventive method described herein, and which—when loaded in a computer system—is able to carry out the method. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The computer program product may be stored on hard disk drives within processing unit 102, as mentioned, or may be located on a remote system such as a server 114, coupled to processing unit 102, via a network interface such as an Ethernet interface. Monitor 106, mouse 114 and keyboard 108 are coupled to the processing unit 102, to provide user interaction. Scanner 124 and printer 122 are provided for document input and output. Printer 122 is shown coupled to the processing unit 102 via a network connection, but may be coupled directly to the processing unit. Scanner 124 is shown coupled to the processing unit 102 directly, but it should be understood that peripherals might be network coupled, or direct coupled without affecting the performance of the processing unit 102.

While it is apparent that the invention herein disclosed is well calculated to fulfill the objectives discussed above, it will be appreciated that numerous modifications and embodiments may be devised by those skilled in the art, and it is intended that the appended claims cover all such modifications and embodiments as fall within the true spirit and scope of the present invention.

1. A method of selectively removing inactive objects from a file to produce a thinner file, the method comprising:
identifying inactive objects of interest in a specified repository file;
listing the identified inactive objects of interest in an input file; and
executing a tool to read the input file and to remove from the specified repository file all of the objects listed in the input file to reduce the number of objects in and the byte size of the specified repository file.

2. The method according to claim 1, wherein the executing includes using the tool to generate a log file identifying defined information about the objects removed from the repository file.

3. The method according to claim 2, wherein the log file includes statistics on actions taken by the tool.

4. The method according to claim 1, wherein the executing includes using a single configuration file to configure and run the tool.

5. The method according to claim 1, wherein some of the objects in the repository file are custom inactive objects and others of the objects in the repository file are active custom objects, and the executing includes:
checking to determine if each of the removed objects is one of the custom inactive objects; and
using the tool to delete all of the custom inactive objects in the repository file by
re-generating a new object file with only active custom objects and replacing the specified repository file with the new object file.

6. The method according to claim 1, wherein the executing includes generating a backup of the object files on which the tool operates.

7. The method according to claim 1, wherein some of the objects in the repository file are custom inactive objects and others of the objects in the repository file are active custom objects, and the executing includes executing the tool to remove from the repository file all of the custom inactive objects in the repository file that have a defined relationship.

8. The method according to claim 1, wherein the repository file includes Object Hierarchy objects and Sub-Object Hierarchy objects, and the executing includes removing from the repository file both Object Hierarchy and Sub-Object Hierarchy objects.

9. The method according to claim 1, wherein the repository file includes Object Hierarchy objects and Sub-Object Hierarchy objects, and each of the Sub-Object Hierarchy objects is a sub-object of one of the Object Hierarchy objects, and the executing includes, when one of the Object Hierarchy objects listed in the input file is removed from the repository file, removing from the repository file all of the Sub-Object Hierarchy objects of said one of the Object Hierarchy objects.

10. The method according to claim 1, wherein the executing includes using the tool to configure custom strings based on which inactive objects are removed from the repository file.

11. An object removing system for selectively removing inactive objects from a file to produce a thinner file, the file removing system comprising one or more processor units configured for:
identifying inactive objects of interest in a specified repository file;
listing the identified inactive objects of interest in an input file; and
executing a tool to read the input file and to remove from the specified repository file all of the objects listed in the input file to reduce the number of objects in and the byte size of the specified repository file.

12. The system according to claim 11, wherein the executing includes using the tool to generate a log file identifying defined information about the objects removed from the repository file.

13. The system according to claim 11, wherein the executing includes using a single configuration file to configure and run the tool.

14. The system according to claim 11, wherein some of the objects in the repository file are custom inactive objects and others of the objects in the repository file are active custom objects, and the executing includes:
checking to determine if each of the removed objects is one of the custom inactive objects; and
using the tool to delete all of the custom inactive objects in the repository file by
re-generating a new object file with only active custom objects and replacing the specified repository file with the new object file.

15. The system according to claim 11, wherein some of the objects in the repository file are custom inactive objects and others of the objects in the repository file are active custom objects, and the executing includes executing the tool to remove from the repository file all of the custom inactive objects in the repository file that have a defined relationship.

16. An article of manufacture comprising:
at least one tangible computer readable medium device having computer readable program code logic tangibility embodied therein to execute instructions in one or more processing units to remove selectively inactive objects from a file to produce a thinner file, said computer readable program code logic, when executing, performing the following:
identifying inactive objects of interest in a specified repository file;
listing the identified inactive objects of interest in an input file; and
executing a tool to read the input file and to remove from the specified repository file all of the objects listed in the input file to reduce the number of objects in and the byte size of the specified repository file.

17. The article of manufacture according to claim 16, wherein the executing includes using the tool to generate a log file identifying defined information about the objects removed from the repository file.

18. The article of manufacture according to claim 16, wherein some of the objects in the repository file are custom inactive objects and others of the objects in the repository file are active custom objects, and the executing includes:
checking to determine if each of the removed objects is one of the custom inactive objects; and
using the tool to delete all of the custom inactive objects in the repository file by re-generating a new object file with only active custom objects and replacing the specified repository file with the new object file.

19. The article of manufacture according to claim 16, wherein the repository file includes Object Hierarchy objects and Sub-Object Hierarchy objects, and the executing includes removing from the repository file both Object Hierarchy and Sub-Object Hierarchy objects.

20. The article of manufacture according to claim 16, wherein the repository file includes Object Hierarchy objects and Sub-Object Hierarchy objects, and each of the Sub-Object Hierarchy objects is a sub-object of one of the Object Hierarchy objects, and the executing includes, when one of the Object Hierarchy objects listed in the input file is removed from the repository file, removing from the repository file all of the Sub-Object Hierarchy objects of said one of the Object Hierarchy objects.
